(19) United States
(12) Patent Application Publication
(10) Pub. No.: US 2012/0051028 A1
(43) Pub. Date: Mar. 1, 2012

(54) LIGHTING DEVICE

(75) Inventor: Louis Montagne, Cailloux sur fontaines (FR)

(73) Assignee: KONINKLIJKE PHILIPS ELECTRONICS N.V., EINDHOVEN (NL)

(21) Appl. No.: 13/319,106

(22) PCT Filed: Apr. 30, 2010
(86) PCT No.: PCT/IB10/51895

§ 371 Date: Nov. 7, 2011

(30) Foreign Application Priority Data
May 7, 2009 (EP) 09305416.1

(51) Int. Cl. F21V 9/16; F21V 29/00; F21V 7/04

(52) U.S. Cl. 362/84

(57) ABSTRACT

A compact LED light source providing improved white light, a color temperature adjustment and a low glare. The lighting device comprises a reflective element having a back surface and a wall including at least one window, said wall and back surface forming a reflective cavity with a light outlet, at least one interferential filter and a luminescent screen able to change a first wavelength band into a second wavelength band of an incident light, said luminescent screen being located onto the back surface of the reflective element. The lighting device is arranged such that light sources located outside the reflective element in front of said interferential filter can be positioned for emitting a light beam directed to the back surface of the reflective element comprising the luminescent screen.

### FIELD OF THE INVENTION

The invention relates in general to a lighting device, such as for example downlight device, that allows to reflect a light providing from a light source (e.g. LEDs) to redirect it towards a determined zone in order to produce a certain lighting.

### BACKGROUND OF THE INVENTION

It is well known that LEDs offer both increased electrical efficiency and lamp life even though they have insufficient individual luminous output to replace most other lamp forms such as incandescent, tungsten halogen and fluorescent for instance. Nevertheless, LEDs can be grouped together in a lighting device such as a LEDs downlight, for example, to accumulate sufficient light output. Remote phosphor LEDs downlights usually comprise at least LEDs, a heat sink, a mixing box, a phosphor screen and a diffuser.

US 2007/026339 discloses such a lighting device comprising LEDs and heat sink placed in the hollow reflector of the lighting device in such a way that they face the bottom side of the reflector and that the light emitted by LEDs can reflect thereon. The reflector further comprises a light outlet provided with a transmitting plate including luminescent material to change the wavelength of the light emitted by LEDs.

Height of remote phosphor LEDs downlight of prior art being equal to the sum of the heights of internal stacked components, remote phosphor LEDs downlight of prior art has a great height value that might cause problems in systems requiring lower downlights.

Moreover, due to this stacked configuration, input cooling air had certain difficulties to correctly pass through the vertical lamellas of the heat sink because masked by the other components.

Furthermore, remote phosphor LEDs downlight of prior art provide an insufficient white color and a smooth glare effect which are not pleasing for the eye and do not allow a color temperature adjustment.

To overcome above-mentioned limitation, a need exists for a compact LED light source providing a good thermal dissipation, a better white color and a reduction of glare and secondarily allowing a color temperature adjustment.

### SUMMARY OF THE INVENTION

It is therefore an object of the invention to provide a lighting device comprising at least one reflective element having a back surface and a wall including at least one window, said wall and back surface forming a reflective cavity with a light outlet, at least one interferential filter, a luminescent screen able to change a first wavelength band into a second wavelength band of an incident light, said luminescent screen being located onto the back surface of the reflective element, wherein the lighting device is arranged such that light sources located outside the reflective element in front of said interferential filter can be positioned for emitting a light beam directed to the back surface of the reflective element comprising the luminescent screen.

In one embodiment, the wall of the reflective element includes a plurality of windows equipped with interferential filters. Each interferential filter is a dichroic filter which reflects the white light and transmits the blue light.

In one embodiment, the outlet of the reflective element is equipped with an interferential filter. Said interferential filter is a dichroic filter which reflects the blue light and transmits the white light.

The luminescent screen is preferably a phosphor screen deposited on the reflecting back surface of the reflective element.

It further comprises at least one thermal conduction element for cooling said plurality of light sources. Said thermal conduction element surrounds the reflective element and extends from the light outlet to the back surface.

In one embodiment the thermal conduction element is designed to bear the plurality of light sources in such a way that these light sources are located in front of said interferential filter(s) and positioned for emitting a light beam generally directed to the back surface of the reflective element comprising the luminescent screen.

To increase the surface area of the thermal conduction element to facilitate heat dissipation via convection, the thermal conduction element comprises a plurality of lamellas.

In one embodiment, said lighting device further comprising a plurality of light sources located outside the reflective element in front of the interferential filter(s) and positioned for generally emitting a light beam to the back surface of the reflective element comprising the luminescent screen.

The plurality of light sources comprises at least partly a plurality of light emitting diodes (LEDs). Accessorily, it further comprises a collimator associated with the light outlet of each LED.

In one embodiment, the reflective element has a dome shape.

### BRIEF DESCRIPTION OF THE DRAWINGS

For a further understanding of the objects and advantages of the present invention, references should be made to the following drawings in conjunction with the accompanying descriptions and operations, wherein:

FIG. 1 shows a schematic sectional view of a representative embodiment of a lighting device according to the present invention,

FIG. 2 shows a bottom perspective view of a representative embodiment of a lighting according to the invention excepted a thermal conduction element

FIG. 3 shows a bottom perspective view of a collimator, a secondary reflector and an interferential filter assembly of the embodiment of a lighting according to the invention,

FIG. 4 shows the energy distribution at the outlet of the lighting according to the present invention in function of the wavelength compared to the energy distribution at the outlet of a lighting of prior art in function of the wavelength,

FIG. 5 shows a lighting intensity distribution out of the luminary of the lighting according to the invention depicted in FIG. 2,

FIG. 6 shows a bottom perspective view of an alternative of a luminary according to the invention excepted a thermal conduction element,

FIG. 7 shows an exploded bottom perspective view of the alternative embodiment of the luminary according to the invention,

FIG. 8 shows a detailed bottom perspective view of a collimator, a secondary reflector and an interferential filter assembly of the alternative embodiment of a luminary according to the invention represented on FIGS. 6 and 7,

FIG. 9 shows a lighting intensity distribution out of luminary of the alternative lighting device according to the invention represented on FIGS. 6 to 8,

FIG. 10 shows a bottom perspective view of a second alternative embodiment of a lighting according to the invention excepted a thermal conduction element,

FIG. 11 shows an exploded bottom perspective view of the second alternative embodiment of the lighting device according to the invention represented on FIG. 10,

FIG. 12 shows a torn bottom perspective view of the second alternative embodiment of the lighting device according to the invention represented on FIGS. 10 and 11.

### DETAILED DESCRIPTION OF EMBODIMENTS

It is emphasized that, in accordance with the standard practice in the industry, various features are not drawn to scale. In fact, the dimensions of the various features may be arbitrarily increased or reduced for clarity of discussion.

For the purpose of promoting an understanding of the present invention, references are made in the text hereof to embodiments of a luminary, only some of which are depicted in the drawings. It is nevertheless understood that no limitations to the scope of the invention are thereby intended.

Furthermore, in the embodiments depicted, like reference numerals refer to identical structural elements in the various drawings.

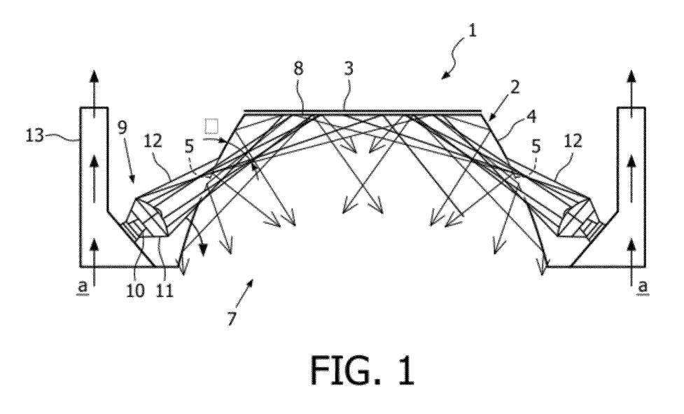

FIG. 1 is a schematic sectional view of one embodiment of a lighting device 1 according to the present invention and shows the main elements of one lighting device 1. The lighting device 1 comprises one reflective element 2 having a back surface 3 and a wall 4 including windows 5 equipped with an interferential filter 6. The wall 4 and the back surface 3 form a reflective cavity with a light outlet 7. The lighting device 1 further comprises a luminescent screen 8 located onto the back surface 3 of the reflective element 2. The luminescent screen 8 is able to change a first wavelength band into a second wavelength band of an incident light. The lighting device 1 further comprises light sources 9 located outside the reflective element 2 in front of interferential filters 6 in such a manner that light sources 9 can emit a light beam directed to the back surface 3 of the reflective element 2 comprising the luminescent screen 8.

In this embodiment, light sources 9 are light emitting diodes 10, LEDs, and more particularly blue LEDs, coupled to a collimator 11 and a secondary reflector 12.

Moreover, the luminescent screen 8 is a phosphor screen, advantageously deposited on the reflecting back surface 3 of the reflective element 2, which change the blue incident light into white light. Each interferential filter 6 is a dichroic filter which reflects the white light and transmits the blue light.

In this embodiment, the reflective back surface 3 is a planar surface; nevertheless, it is understood that the reflective back surface 3 may have a convex or a concave surface without departing of the scope of the invention.

Furthermore, the lighting device 1 according to the invention comprises a thermal conduction element 13 that surrounds the reflective element 2. The thermal conduction element 13 extends from the light outlet 7 to the back surface 3 of the reflective element 2.

A part of the thermal conduction element 13 is designed to bear the plurality of light sources 9 in such a way that these light sources 9 are located in front of interferential filter(s) 6 and positioned for emitting a light beam generally directed to the back surface 3 of the reflective element 2 comprising the luminescent screen 8.

It is obvious that light sources 9 could be beard by an intermediary element coupled to the reflective element 2 and/or the thermal conduction element 13 without departing of the scope of the invention.

Moreover, the thermal conduction element 13 comprises a plurality of lamellas. Lamellas are included to increase the surface area of the thermal conduction element 13 to facilitate heat dissipation via convection represented by arrow a. The thermal conduction element 13 is usually made of aluminium, but can be made of any suitable material capable of absorbing the heat generated by LEDs and dissipating it to the environment. The thermal conduction element 13 could also be construed from a formed sheet-metal part or die cast for example.

It should be noted that the position of the thermal conduction element 13 surrounding the reflective element 2 and light sources 9 reduces substantially the height of the lighting device 1 compared to the height of lighting devices of prior art.

The blue light emitted by LEDs of light sources 9 passes through windows 5 and interferential filters 6 transmitting blue radiations and reflecting radiations higher in wavelength than blue. When the blue light reaches the phosphor screen 8, said phosphor screen 8 transforms the main incident blue light into white light which is reflected by the back surface 3 of the reflective element 2. Consequently the white light is redirected downwards, reflecting itself on the wall 4 of the reflective element 2 and on internal surface of interferential filters 6 which reflects the white light and transmit blue light, and falls down from the light outlet 7. Only a small part of the blue light emitted by light sources 9 is reflected by the phosphor screen 8. Said reflected blue light may pass again through interferential filters 6, internal surface of interferential filters 6 reflecting the white light and transmitting blue light. The ratio of blue light can be adjusted by surface ratio of reflective surface of the reflective element 2 and internal surface of interferential filters 6.

By adjusting the external radius of curvature of the collimator 11 associated with the light outlet of each LED 10, i.e by adjusting the convergence of the collimator 11, it is possible to adjust the surface of interferential filters 6 allowing the passage of light without losses in a more or less large hole. By this way, the lighting device according to the invention increases the white color by moving back part of blue radiations.

Moreover, it should be noted that by increasing the average incidence angle of a beam with interferential filters 6, it is possible to move the pass band of the filter in the high wavelength providing a decrease of the color temperature.

In this embodiment depicted in FIG. 1, the axis of the collimator 11 associated with each LED 10 forms an angle θ with the interferential filters 6. When the axis of the collimators 11 are tilted in direction of the arrow a (FIG. 1), in such a manner that the axis of collimators 11 forms an angle lower than angle θ, it is possible to move the pass band of the filter in the higher wavelength having as consequences to decrease the color temperature of the luminary.

Secondarily, thanks to the phosphor screen 8 positioned onto the back surface 3 of the reflective element 2, the necessary low glare of the lighting device is preserved by the wall 4 of the reflective element 2.

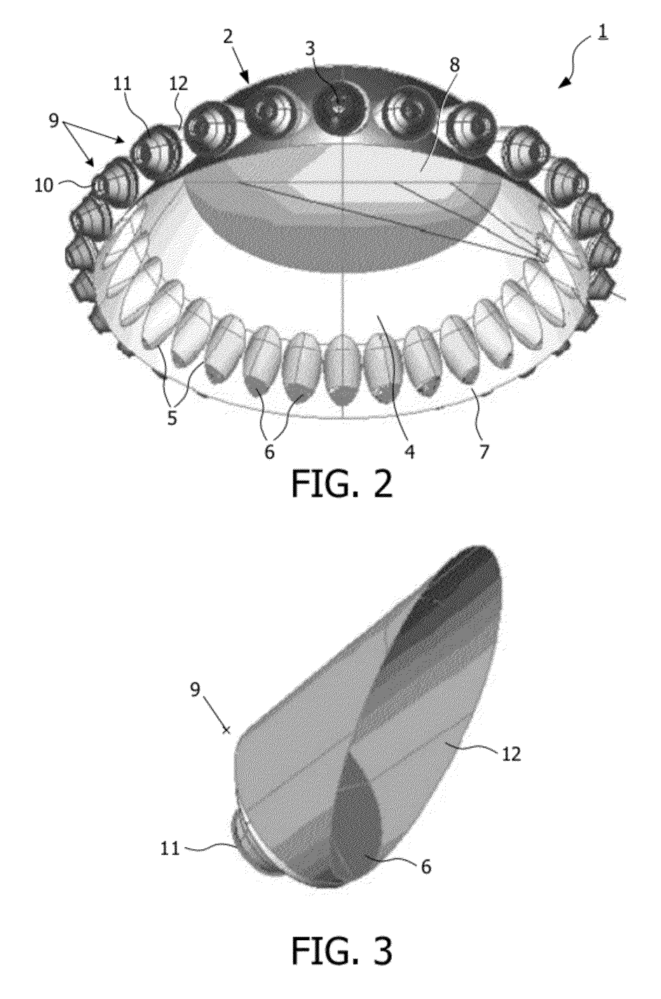

FIG. 2 is a bottom perspective view of one embodiment of the lighting device which comprises one reflective element having a dome shape including a planar back surface 3 and a wall 4 including windows 5. Said windows present an elliptic shape and are regularly spaced out at the bottom of the reflective element 2. The wall 4 and the back surface 3 form a reflective cavity with a light outlet 7.

The lighting device 1 further comprises a luminescent screen 8 located onto the back surface 3 of the reflective element 2. The luminescent screen 8 is able to change a first wavelength band into a second wavelength band of an incident light. The luminescent screen 8 is a phosphor screen, advantageously deposited on the reflecting back surface 3 of the reflective element 2, which change the blue incident light into white light.

The lighting device 1 further comprises light sources 9 located outside the reflective element 2 in front of windows 5 in such a manner that light sources 9 can emit a light beam directed to the back surface 3 of the reflective element 2 comprising the luminescent screen 8.

In this embodiment, referring to FIGS. 2 and 3, light sources 9 are light emitting diodes 10, LEDs, and more particularly blue LEDs, coupled to a collimator 11 and a secondary reflector 12. An interferential filter 6 consisting in a dichroic filter which reflects the white light and transmits the blue light is positioned at the outlet of each collimator 11, between said collimator and the secondary reflector 12.

Optionally, only one or a part of the LEDs emits blue light and another part of the LEDs emits at least another colour (e.g. red, green, amber). In this specific embodiment one may choose not providing any interferential filters 6 between the collimators 11 of these LEDs of another colour and the corresponding secondary reflectors 12. This embodiment allows a light designer to mix different emitted colours to reach certain light effects, such as changing the nature of the white colour outputting the luminary (e.g. cold to warm white) or slightly modifying the colour of the light output.

It should be noted that, in this embodiment, the thermal conduction element is not depicted. Nevertheless, the thermal conduction element could have a tubular shape that surrounds the reflective element 2, said thermal conduction shape including radial lamellas for example. The thermal conduction element should extend from the light outlet 7 to the back surface 3 of the reflective element 2.

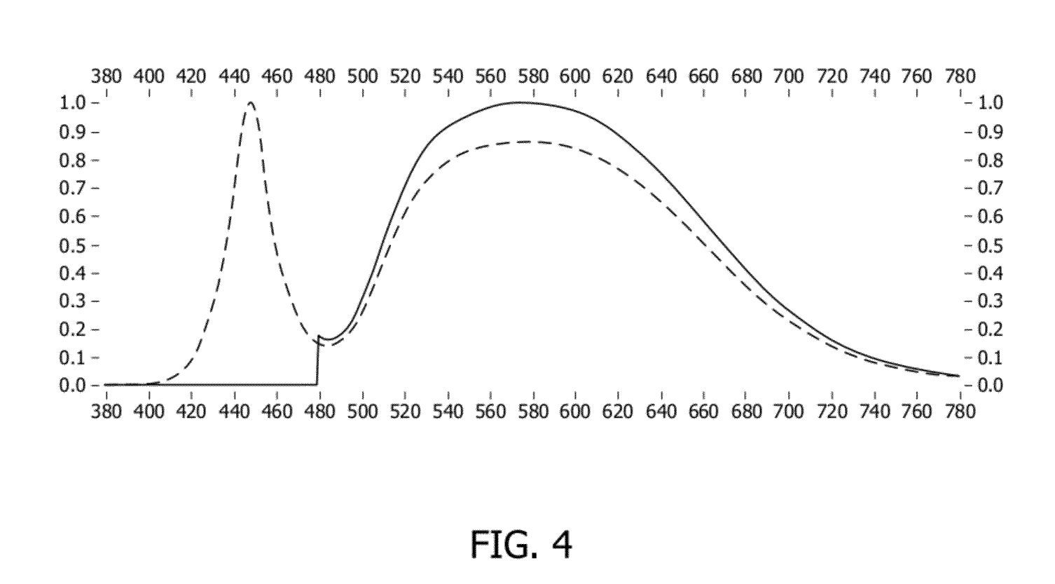

Referring to FIG. 4, the construction of the lighting device according to the invention provides a removing from the spectrum the 380-480 band that reduces from 1.4% the Amount of lumen.

In this embodiment, the lighting device comprises twenty-eight windows.

Considering that the same quantity of flux by unit of surface falls on all reflective surface of the reflective element 2 and not on the interferential filters 6, the surface of the reflective element is equal to 15420 mm2, the output surface of each collimator is equal to 112.5 mm2 and the total surface of the interferential windows is equal to 3150 mm2 (112.5 mm2×28). The ratio between the surface of the reflective element 2 and the total surface of the interferential windows is equal to 4.89 (15420 mm2/3150 mm2) Consequently, looses due to the interferential windows is equal to 0.28% (1.4%/4.89). The surface reflecting the total spectrum is 4.89 times more important than the surface with interferential treatment.

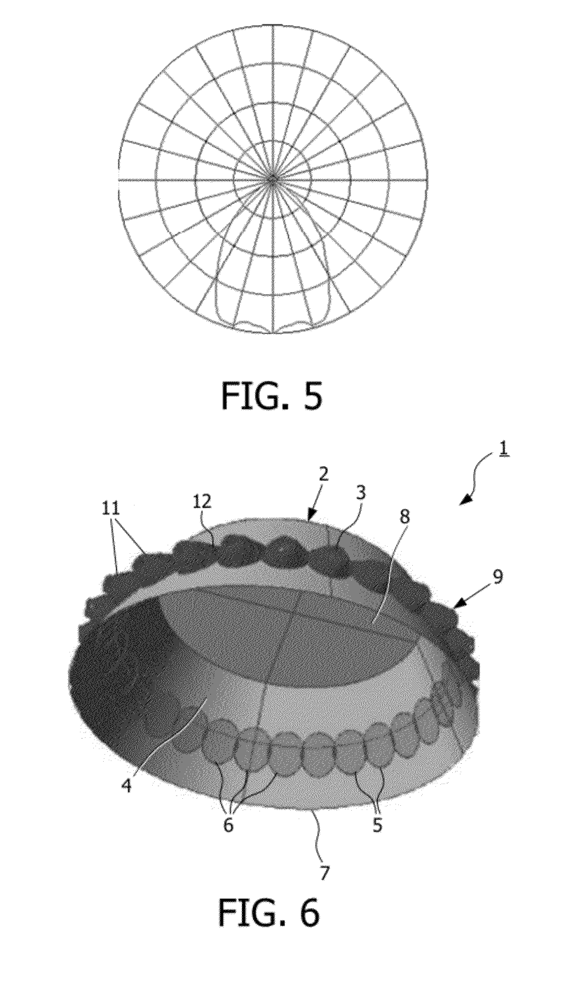

Moreover, referring to FIG. 5, the Unified Glare Rating (UGR) 4H/8H 752 is equal to 21.9 according to the European Norm EN 13032 and the optical efficiency between phosphor screen and outlet is equal to 91.5% for a base of 1246 Lm (Flux out the phosphor screen).

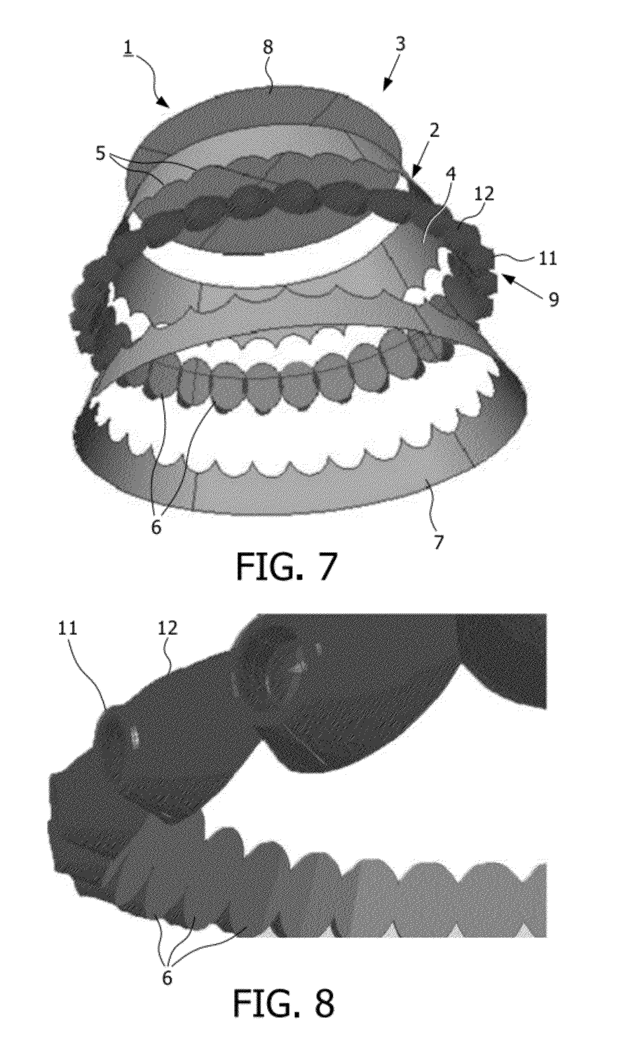

FIGS. 6 to 8 are perspective view of another embodiment of the lighting device which comprises one reflective element 2 having a dome shape including a planar back surface 3 and a wall 4 including windows 5. Said windows 5 present an elliptic shape and are adjacent one with each other in the middle part of the reflective element 2. The wall 4 and the back surface 3 form a reflective cavity with a light outlet 7.

The lighting device 1 further comprises a luminescent screen 8 located onto the back surface 3 of the reflective element 2. The luminescent screen 8 is able to change a first wavelength band into a second wavelength band of an incident light. The luminescent screen 8 is a phosphor screen, advantageously deposited on the reflecting back surface 3 of the reflective element 2, which change the blue incident light into white light.

The lighting device 1 further comprises light sources 9 located outside the reflective element 2 in front of windows 5 in such a manner that light sources 9 can emit a light beam directed to the back surface 3 of the reflective element 2 comprising the luminescent screen 8.

In this embodiment, referring to FIGS. 6 to 8, light sources 9 are light emitting diodes 10, LEDs, and more particularly blue LEDs, coupled to a collimator 11 and a secondary reflector 12. An interferential filter 6 consisting in a dichroic filter which reflects the white light and transmits the blue light is positioned at the outlet of each secondary reflector 12 in such a manner that each window 5 is equipped with an interferential filter 6.

Optionally, only one or a part of the LEDs emits blue light and another part of the LEDs emits at least another colour (e.g. red, green, amber). In this specific embodiment one may choose not providing any interferential filters 6 between the collimators 11 of these LEDs of another colour and the corresponding secondary reflectors 12. This embodiment allows a light designer to mix different emitted colours to reach certain light effects, such as changing the nature of the white colour outputting the luminary (e.g. cold to warm white) or slightly modifying the colour of the light output.

It should be noted that, in this embodiment, the thermal conduction element is not depicted. Nevertheless, the thermal conduction element could have a tubular shape that surrounds the reflective element 2, said thermal conduction shape including radial lamellas for example. The thermal conduction element should extend from the light outlet 7 to the back surface 3 of the reflective element 2.

Referring to FIG. 4, the construction of the lighting device according to the invention provides a removing from the spectrum the 380-480 band that reduces from 1.4% the Amount of lumen.

In this embodiment, the lighting device comprises twenty-eight windows.

Considering that the same quantity of flux by unit of surface falls on all reflective surface of the reflective element 2 and not on the interferential filters 6, the surface of the reflective element is equal to 10846.5 mm2 (15420-4573.5 mm2), the output surface of each collimator is equal to 163.34 mm2 and the total surface of the interferential windows is equal to 4573.5 mm2 (163.34 mm2×28). The ratio between the surface of the reflective element 2 and the total surface of the interferential windows is equal to 2.37 (10846.5 mm2/3150 mm2) Consequently, looses due to the interferential windows is equal to 0.59% (1.4%/2.37). The surface reflecting the total spectrum is 2.37 times more important than the surface with interferential treatment.

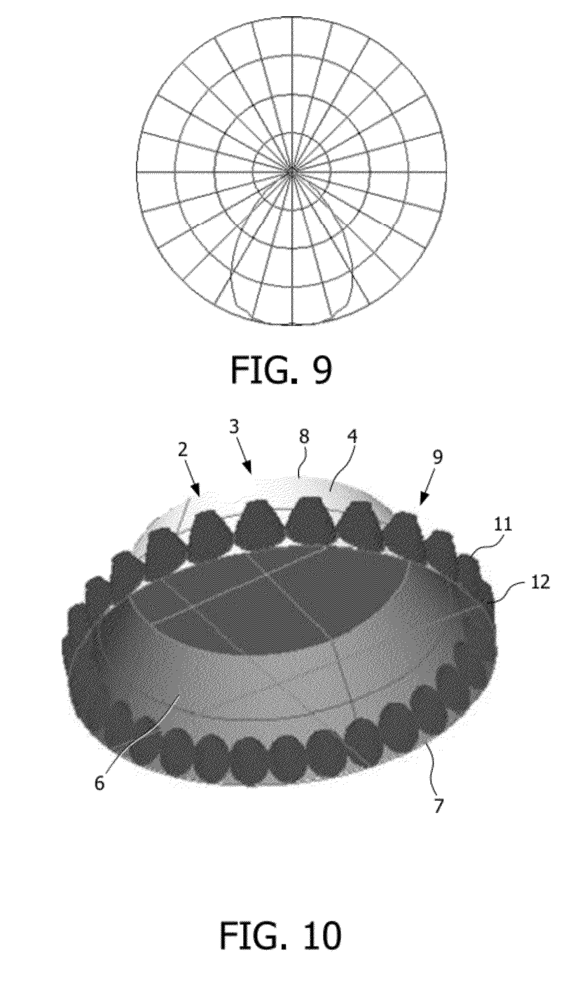

Moreover, referring to FIG. 9, the Unified Glare Rating (UGR) 4H/8H 752 is equal to 21.0 according to the European Norm EN 13032 and the optical efficiency between phosphor screen and outlet is equal to 94% for a base of 1246 Lm (Flux out the phosphor screen).

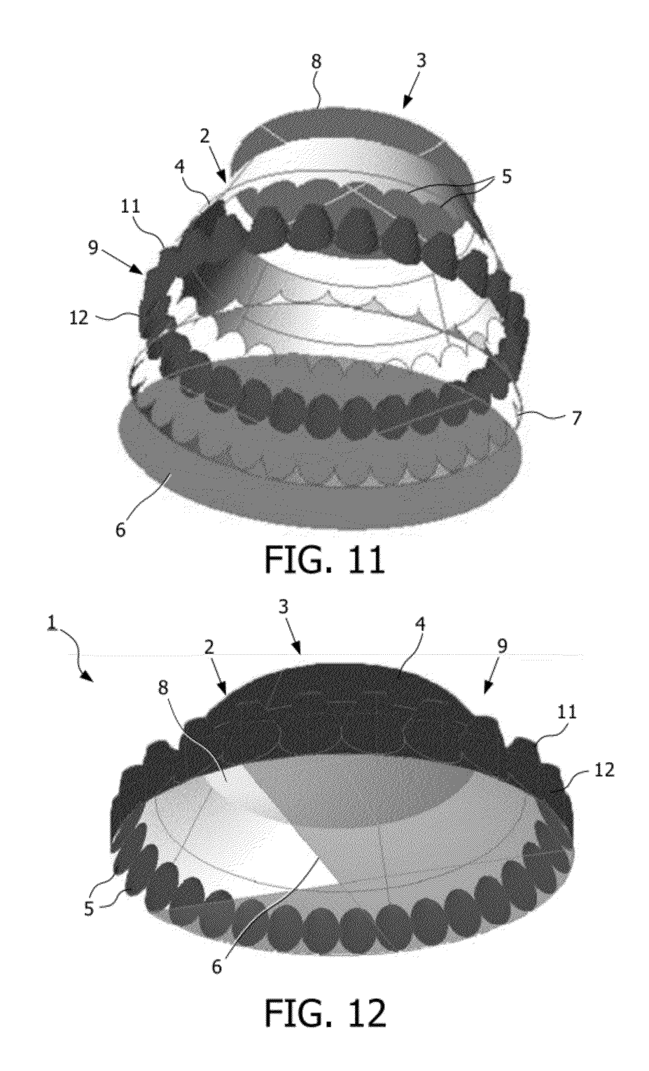

FIGS. 10 to 12 are perspective view of another embodiment of the lighting device which comprises one reflective element 2 having a dome shape including a planar back surface 3 and a wall 4 including windows 5. Said windows 5 present an elliptic shape and are adjacent one with each other at the bottom of the reflective element 2. The wall 4 and the back surface 3 form a reflective cavity with a light outlet 7.

The lighting device 1 further comprises a luminescent screen 8 located onto the back surface 3 of the reflective element 2. The luminescent screen 8 is able to change a first wavelength band into a second wavelength band of an incident light. The luminescent screen 8 is a phosphor screen, advantageously deposited on the reflecting back surface 3 of the reflective element 2, which change the blue incident light into white light.

The lighting device 1 further comprises light sources 9 located outside the reflective element 2 in front of windows 5 in such a manner that light sources 9 can emit a light beam directed to the light outlet 7 of the reflective element 2 comprising the luminescent screen 8.

In this embodiment, referring to FIGS. 10 to 12, light sources 9 are light emitting diodes 10, LEDs, and more particularly blue LEDs, coupled to a collimator 11 and a secondary reflector 12.

Optionally, only one or a part of the LEDs emits blue light and another part of the LEDs emits at least another colour (e.g. red, green, amber). This embodiment allows a light designer to mix different emitted colours to reach certain light effects, such as changing the nature of the white colour outputting the luminary (e.g. cold to warm white) or slightly modifying the colour of the light output.

An interferential filter 6 consisting in a dichroic filter which reflects the blue light and transmits the white light is positioned at the light outlet 7 of the reflective element 2.

It should be noted that, in this embodiment, the thermal conduction element is not depicted. Nevertheless, the thermal conduction element could have a tubular shape that surrounds the reflective element 2, said thermal conduction shape including radial lamellas for example. The thermal conduction element should extend from the light outlet 7 to the back surface 3 of the reflective element 2.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims.

1. A lighting device comprising:
at least one reflective element having a back surface and a wall including at least one window, said wall and back surface forming a reflective cavity with a light outlet,
at least one interferential filter,
a luminescent screen able to change a first wavelength band into a second wavelength band of an incident light, said luminescent screen being located onto the back surface of the reflective element,
wherein the lighting device is arranged such that light sources located outside the reflective element in front of said interferential filter can be positioned for emitting a light beam directed or reflected to the back surface of the reflective element comprising the luminescent screen.

2. Lighting device of claim 1, wherein the wall of the reflective element includes a plurality of windows equipped with interferential filters.

3. Lighting device of claim 1 wherein each interferential filter is a dichroic filter which reflects the white light and transmits the blue light.

4. Lighting device of claim wherein the outlet of the reflective element is equipped with an interferential filter.

5. Lighting device of claim 4 wherein each interferential filter is a dichroic filter which reflects the blue light and transmits the white light.

6. Lighting device of claim 1 wherein the luminescent screen is a phosphor screen.

7. Lighting device of claim 6 wherein the phosphor screen is deposited on the reflecting back surface of the reflective element.

8. Lighting device of claim 1 wherein it further comprises at least one thermal conduction element for cooling said plurality of light sources.

9. Lighting device of claim 8 wherein the thermal conduction element surrounds the reflective element.

10. Lighting device of claim 9 wherein the thermal conduction element extends from the light outlet to the back surface.

11. Lighting device of claim 9 wherein a part of the thermal conduction element is designed to bear the plurality of light sources in such a way that these light sources are located in front of said interferential filter(s) and positioned for emitting a light beam generally directed to the back surface of the reflective element comprising the luminescent screen.

12. Lighting device of claim 9 wherein the thermal conduction element comprises a plurality of lamellas.

13. Lighting device of claim 1, further comprising a plurality of light sources located outside the reflective element in front of the interferential filter(s) and positioned for generally emitting a light beam to the back surface of the reflective element comprising the luminescent screen.

14. Lighting device of claim 13, wherein the plurality of light sources comprises at least partly a plurality of light emitting diodes (LEDs).

15. Lighting device of claim 13 further comprising a collimator associated with the light outlet of each LED.

16. Lighting device of claim 1, wherein the reflective element has a dome shape.
